(19) United States
(12) Patent Application Publication
(10) Pub. No.: US 2026/0182557 A1
(43) Pub. Date: Jul. 2, 2026

(54) INTELLIGENT BRAKING METHOD AND FISHING REEL

(71) Applicant: Shenzhen Bosaidong Technology Co., Ltd., Shenzhen (CN)

(72) Inventors: Zhiyuan Yu, Shenzhen (CN); Le Xiao, Shenzhen (CN); Tianshi Cui, Shenzhen (CN)

(21) Appl. No.: 19/055,586

(22) Filed: Feb. 18, 2025

(30) Foreign Application Priority Data
Dec. 31, 2024 (CN) 202411989987.4

(51) Int. Cl. A01K 89/033

(52) U.S. Cl. CPC A01K 89/033

(57) ABSTRACT

Disclosed are an intelligent braking method and a fishing reel. The method includes: collecting real-time casting data of the fishing reel during casting; identifying a current casting posture and/or a current bait type according to the real-time casting data, and confirming a current braking mode; calculating a current braking gear required in the current braking mode according to the real-time casting data, and outputting a corresponding real-time braking force. In the present invention, during the casting of the fishing reel, the current casting posture and the current bait type are identified. Based on the collected real-time casting data, the current braking mode is confirmed. Then, based on the real-time casting data, the current braking gear and the real-time braking force required in the current braking mode are also confirmed. The whole braking process is completed automatically, thus providing a better user experience.

### CROSS REFERENCES TO RELATED APPLICATION

The present invention claims the benefit of Chinese Patent Application No. 202411989987.4 filed on Dec. 31, 2024, the contents of which are incorporated herein by reference in their entirety.

### TECHNICAL FIELD

The present invention relates to the technical field of fishing data processing, and more particularly, to an intelligent braking method and a fishing reel.

### BACKGROUND ART

The braking scheme of the existing fishing reel calculates the braking force through three factors, which are casting type, braking gear, and braking stage, respectively. There are different braking gears under different casting types, and different braking forces are respectively preset to match under each gear according to the braking stage.

This braking scheme needs manual adjustment of the braking mode and braking gear, which is still not intelligent enough, and thus affects the user experience.

### SUMMARY OF THE INVENTION

The object of the present invention is to provide an intelligent braking method and a fishing reel, aiming to solve the problem of poor user experience caused by the need to manually adjust the braking mode and the braking gear during the casting of an existing fishing reel.

In a first aspect, embodiments of the present invention provide an intelligent braking method applied to a fishing reel, including:
collecting real-time casting data of the fishing reel during casting;
identifying a current casting posture and/or a current bait type according to the real-time casting data, and confirming a current braking mode; and
calculating a current braking gear required in the current braking mode according to the real-time casting data, and outputting a corresponding real-time braking force.

In a second aspect, embodiments of the present invention provide a fishing reel including a memory and a processor, the memory having stored therein a computer program which when executed by the processor implements the intelligent braking method as described above.

Advantageous effects of embodiments of the present invention are: during the casting of the fishing reel, the current casting posture and the current bait type are identified to confirm the current braking mode based on the collected real-time casting data, and then continues to confirm the current braking gear and the real-time braking force required in the current braking mode based on the real-time casting data; the user does not need to manually adjust the braking mode and braking gear, the whole braking process is completed automatically, and the user experience is better.

Based on the function of automatically adjusting the braking mode and braking gear, the fishing reel can be designed in different styles without a knob or with a knob, which adds more diversified options for the product. The style without a knob can make the appearance of a fishing reel more concise, while the style with a knob retains the knob shift operation habit of traditional fishing reel, which meets the needs of different users.

### BRIEF DESCRIPTION OF THE DRAWINGS

In order to more clearly illustrate the technical solutions of the embodiments of the present invention, a brief description will be given below with reference to the accompanying drawings which are used in the description of the embodiments. It is obvious that the drawings in the description below are some embodiments of the present invention, and other drawings can be obtained from these drawings by a person skilled in the art without involving any inventive effort.

FIG. 1 is a schematic flow diagram of an intelligent braking method according to an embodiment of the present invention.

FIG. 2 is a schematic sub-flow diagram of an intelligent braking method according to an embodiment of the present invention.

FIG. 3 is another schematic sub-flow diagram of an intelligent braking method according to an embodiment of the present invention.

FIG. 4 is yet another schematic sub-flow diagram of an intelligent braking method according to an embodiment of the present invention.

FIG. 5 is a further schematic sub-flow diagram of an intelligent braking method according to an embodiment of the present invention.

FIG. 6 is a schematic flow diagram illustrating a method for dividing flight stages according to an embodiment of the present invention.

FIG. 7 is a schematic block diagram of a fishing reel according to an embodiment of the present invention.

FIG. 8 is an exemplary graph of a real-time rotation speed and a corresponding real-time rotation speed change rate during casting according to an embodiment of the present invention.

### DETAILED DESCRIPTION OF THE INVENTION

The embodiments of the present invention will now be described more fully hereinafter with reference to the accompanying drawings, in which some, but not all embodiments of the invention are shown. Based on the embodiments of the present invention, all other embodiments obtained by a person of ordinary skill in the art without inventive effort fall within the scope of the present invention.

It will be understood that the terms “comprise” and “include”, when used in this specification and the appended claims, specify the presence of stated features, integers, steps, operations, elements, and/or components, but do not preclude the presence or addition of one or more other features, integers, steps, operations, elements, components, and/or groups thereof.

It is also to be understood that the terminology used in the description of the invention herein is for the purpose of describing particular embodiments only and is not intended to be limiting to the invention. As used in the description of the invention and the appended claims, the singular forms “a”, “an”, and “the” are intended to include the plural forms as well, unless the context clearly indicates otherwise.

It should be further understood that the term “and/or” as used in the present specification and appended claims refers to and includes any and all possible combinations of one or more of the associated listed items.

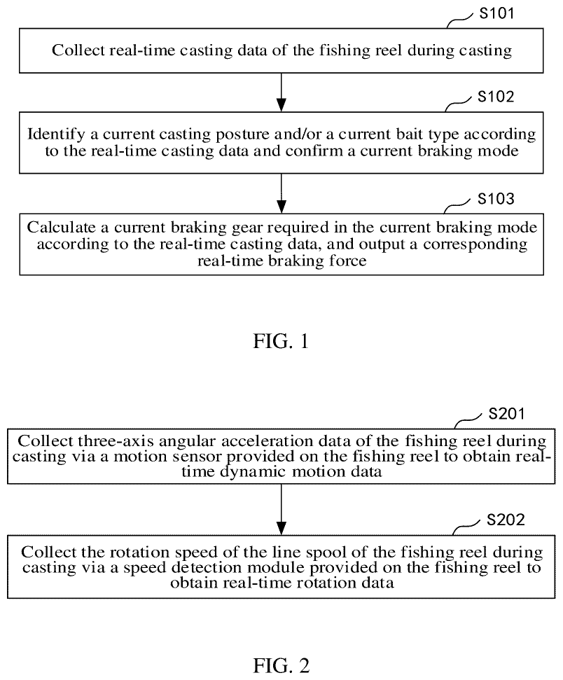

Referring to FIG. 1, FIG. 1 is a schematic flow diagram of an intelligent braking method according to an embodiment of the present invention.

As shown in FIG. 1, the method includes steps S101 to S103.
S101, collecting real-time casting data of the fishing reel during casting;
in this step, various types of sensors can be built into the fishing reel to collect real-time casting data when the fishing reel is cast.
S102, identifying a current casting posture and/or a current bait type according to the real-time casting data, and confirming a current braking mode.

In this step, different casting postures and bait types correspond to different braking force modes so as to realize intelligent control of the braking force of the fishing reel.
S103, calculating a current braking gear required in the current braking mode according to the real-time casting data, and outputting a corresponding real-time braking force.

In this step, after confirming the current braking mode, further confirming the required current braking gear through real-time casting data, and then automatically calculating a corresponding real-time braking force under the current braking gear using the real-time casting data to perform real-time braking control.

Based on steps S101-S103, during the casting of the fishing reel, the current casting posture and the current bait type are identified to confirm the current braking mode based on the collected real-time casting data, and then continues to confirm the current braking gear and the real-time braking force required in the current braking mode based on the real-time casting data; the user does not need to manually adjust the braking mode and braking gear, the whole braking process is completed automatically, and the user experience is better.

Based on the function of automatically adjusting the braking mode and braking gear, the fishing reel can be designed in different styles without a knob or with a knob, which adds more diversified options for the product. The style without a knob can make the appearance of a fishing reel more concise, while the style with a knob retains the knob shift operation habit of traditional fishing reel, which meets the needs of different users.

In this embodiment, the real-time braking force during casting can be characterized in different ways and can be characterized by using a duty cycle, and the larger the duty cycle is, the larger the real-time braking force is, and the real-time braking force mentioned later can all refer to the duty cycle. However, it is obvious that other data indicators can be used to characterize the braking force in other embodiments, and such substitutions and modifications fall within the scope of the present application.

In an embodiment, as shown in FIG. 2, step S101 includes:
S201, collecting three-axis angular acceleration data of the fishing reel during casting via a motion sensor provided on the fishing reel to obtain real-time dynamic motion data;
S202, collecting the rotation speed of the line spool of the fishing reel during casting via a speed detection module provided on the fishing reel to obtain real-time rotation data.

In this embodiment, step S201 may collect three-axis angular acceleration data during the casting of the fishing reel via a motion sensor; and extract real-time dynamic motion data from three-axis angular acceleration data; wherein the dynamic motion data includes: the forward angle change, the reverse angle change, the maximum angular acceleration and the minimum angular acceleration of the y-axis, and the forward angle change, the reverse angle change, the maximum angular acceleration and the minimum angular acceleration of the z-axis.

In this embodiment, step S202 can detect the rotation speed of the line spool by means of a speed detection module provided on the fishing reel so as to obtain real-time rotation data; specifically, during casting, the magnet located on the line spool rotates along with the line spool, rotation data of the magnet is detected by a speed detection module, a square-wave periodic pulse signal is generated every rotation, the square-wave periodic pulse signal changes from high to low and then changes to high, an interrupt 1 is triggered when the signal changes to low and timing is started by a timer, and an interrupt 2 is triggered when the signal changes from low to high and timing is completed; in this way, real-time rotation data is obtained.

Three embodiments of confirming the current braking mode in step S102 are described below:

### Embodiment I

Matching a braking mode based on a casting posture, specifically including: inputting the real-time dynamic motion data into a posture classification model to perform casting posture prediction, and output the current casting posture; matching a braking mode corresponding to a current casting posture in a preset first braking mode table as a current braking mode.

In Embodiment I, an xgboost model can be selected as the posture classification model, and model parameters of the xgboost model are trained using historical dynamic motion data sets of the historical cast; real-time dynamic motion data of the fishing reel when the current cast is input into the trained xgboost model so as to output the current casting posture, wherein the casting posture can include six kinds of postures such as over-shoulder cast, side cast, swing cast, long cast, water float and ejection.

In Embodiment I, the first braking mode table is shown in Table 1 below.

TABLE 1

| Casting posture | Braking mode |
|---|---|
| Over-shoulder cast | General use |
| Side cast | General use |
| Long cast | Long cast |
| Swing cast | Swing cast |
| Float | Float |
| Ejection | Ejection |

Based on this, the corresponding current braking mode can be confirmed from Table 1 after the current casting posture output by the posture classification model.

### Embodiment II

Matching a braking mode based on a bait type, specifically including: inputting real-time rotation data into a bait type classification model for bait type prediction, and outputting the current bait type; matching a braking mode corresponding to the current bait type in a preset second braking mode table as a current braking mode.

In Embodiment II, the input of the bait classification model is the rotation data at the rising stage in the real-time rotation data, and mainly includes 11 features as shown in the following Table 2:

TABLE 2

| Characteristics | Remarks | Characteristics | Remarks |
|---|---|---|---|
| max_speed | Maximum | max_speed/ | The ratio of maximum |
| | rotation speed | max_diff | speed to maximum |
| | | | acceleration |
| max_speed_{—} | Number of | max_speed_{—} | Difference between the |
| time | turns from 0 to | time − | number of turns at |
| | maximum | max_diff_{—} | maximum speed and |
| | rotation speed | time | the number of turns at |
| | | | maximum acceleration |
| max_speed_{—} | Average | | |
| mean | rotation speed | | |
| max_diff | Maximum | acc_xyz_max | Casting maximum |
| | acceleration | | strength |
| max_diff_{—} | Number of | acc_xyz_max/ | The ratio of casting |
| time | turns from 0 to | max_speed | strength to maximum |
| | maximum | | speed |
| | acceleration | | |
| max_diff_{—} | Average | acc_xyz_max/ | The ratio of casting |
| mean | rotation speed | max_diff | strength to maximum |
| | change rate | | acceleration |

Input the features in Table 2 into a bait species classification model for bait type prediction, and then output the current bait type. Then, the corresponding current braking mode can be confirmed based on the following second braking mode table (Table 3).

TABLE 3

| Bait type | Braking mode |
|---|---|
| General bait | General use |
| Light bait | Light bait |
| Wind resistance bait | Wind resistance |

### Embodiment III

Referring to FIG. 3, matching the braking mode based on the casting posture and the bait type, specifically including:
S301, inputting the real-time dynamic motion data into a posture classification model to perform casting posture prediction, and output the current casting posture;
S302, inputting real-time rotation data into a bait type classification model for bait type prediction, and output the current bait type; and
S303, obtaining the current braking mode according to the current casting posture and the current bait type.

In this embodiment, the posture classification model in step S301 is the same as that in Embodiment I, and an xgboost model can be selected, and six kinds of postures such as over-shoulder cast, side cast, swing cast, long cast, float, and ejection can also be output.

In this embodiment, the bait classification model of step S302 is mainly used for bait type prediction under two casting postures of over-shoulder cast and side cast. Specifically, when the casting posture is an over-shoulder cast or a side cast, the rotation data (i.e., the above-mentioned 11 features in Table 2) in the rising stage in the real-time rotation data is input into a bait species classification model to predict the bait type, and the current bait type can be output; among them, the bait types corresponding to over-shoulder cast and side cast include general baits, wind resistance baits, and light baits. However, the four casting postures of swing cast, long cast, float, and ejection do not need to identify the fishing bait type and a corresponding braking mode can be directly matched, and specific reference can be made to the third braking mode table shown in the following table 4.

TABLE 4

| Casting posture | Bait type | Braking mode |
|---|---|---|
| Over-shoulder cast | General bait | General use |
| Side cast | Light bait | Light bait |
| | Wind resistance bait | Wind resistance |
| Long cast | Fishing bait identification | Long cast |
| Swing cast | is not performed, and the | Swing cast |
| Float | braking mode is matched | Float |
| Ejection | only by casting posture | Ejection |

Based on this, after the corresponding current casting posture and bait type are confirmed by the posture classification model and the bait type classification model, the corresponding current braking mode can be confirmed in Table 4.

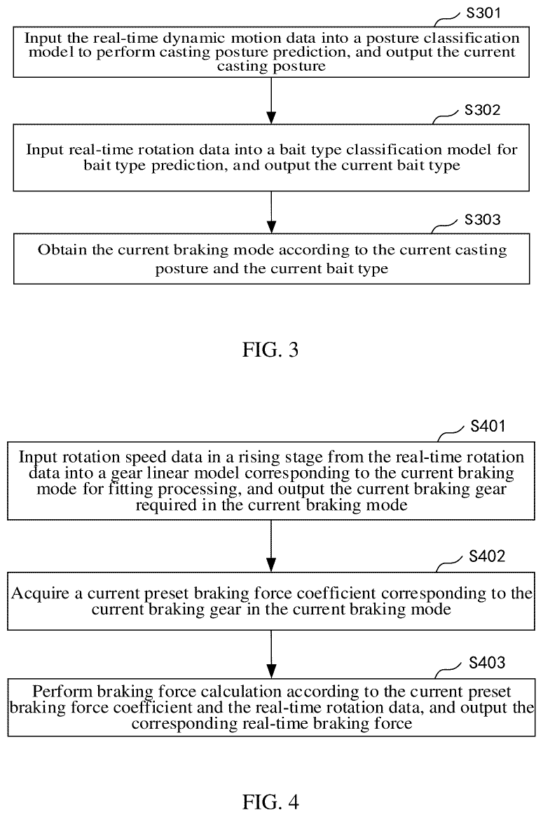

In an embodiment, as shown in FIG. 4, step S103 includes:
S401, inputting rotation speed data in a rising stage from the real-time rotation data into a gear linear model corresponding to the current braking mode for fitting processing, and outputting the current braking gear required in the current braking mode;
S402, acquiring a current preset braking force coefficient corresponding to the current braking gear in the current braking mode; and
S403, performing braking force calculation according to the current preset braking force coefficient and the real-time rotation data and outputting the corresponding real-time braking force.

In step S401 of the present embodiment, each braking mode corresponds to one gear linear model, and taking the above-mentioned third embodiment for confirming the current braking mode as an example, seven braking modes correspond to seven gear linear models; inputting the features corresponding to the above-mentioned table 1 in the current real-time rotation data into a corresponding gear linear model for fitting processing, i.e. outputting the current braking gear required in the current braking mode.

In step S402 of the present embodiment, preset braking force coefficient data corresponding to each braking gear in each braking mode is pre-constructed, and after confirming the current braking mode and the current braking gear, the corresponding preset braking force coefficient can be invoked.

In step S403 of the present embodiment, based on the preset braking force coefficient confirmed in step S402, an appropriate real-time braking force can be automatically calculated by using the preset braking force coefficient and real-time rotation data via software algorithm processing, so as to perform braking control on the process of casting the fishing reel.

In one embodiment, as shown in FIG. 5, step S403 includes:
S501, in the rising stage of casting, outputting the real-time braking force as a fixed braking force, wherein the selected value range of the braking duty cycle of the fixed braking force is [0%, 10%];
S502, in the falling stage of casting, inputting the current preset braking force coefficient and the real-time rotation data into a braking force algorithm to perform a real-time braking force calculation and outputting the real-time braking force corresponding to the falling stage.

In this embodiment, there are different flight stages (i.e., a rising stage and a falling stage) during casting of the fishing reel, and the different flight stages require corresponding braking forces to be matched, and the rotation speed of the line spool of the fishing reel is controlled by outputting different braking forces during the different flight stages so as to perform braking control on the casting of the fishing reel.

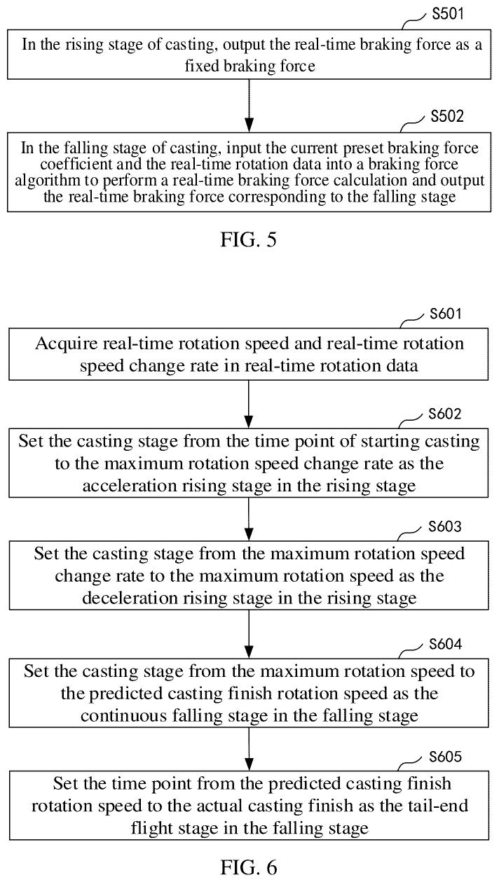

Specifically, as shown in FIG. 6, the flight stage of the cast of the fishing reel can be divided using steps S601 to S605.
S601, acquiring real-time rotation speed and real-time rotation speed change rate in real-time rotation data;
S602, setting the casting stage from the time point of starting casting to the maximum rotation speed change rate as the acceleration rising stage in the rising stage;
S603, setting the casting stage from the maximum rotation speed change rate to the maximum rotation speed as the deceleration rising stage in the rising stage;
S604, setting the casting stage from the maximum rotation speed to the predicted casting finish rotation speed as the continuous falling stage in the falling stage;
S605, setting the time point from the predicted casting finish rotation speed to the actual casting finish as the tail-end flight stage in the falling stage.

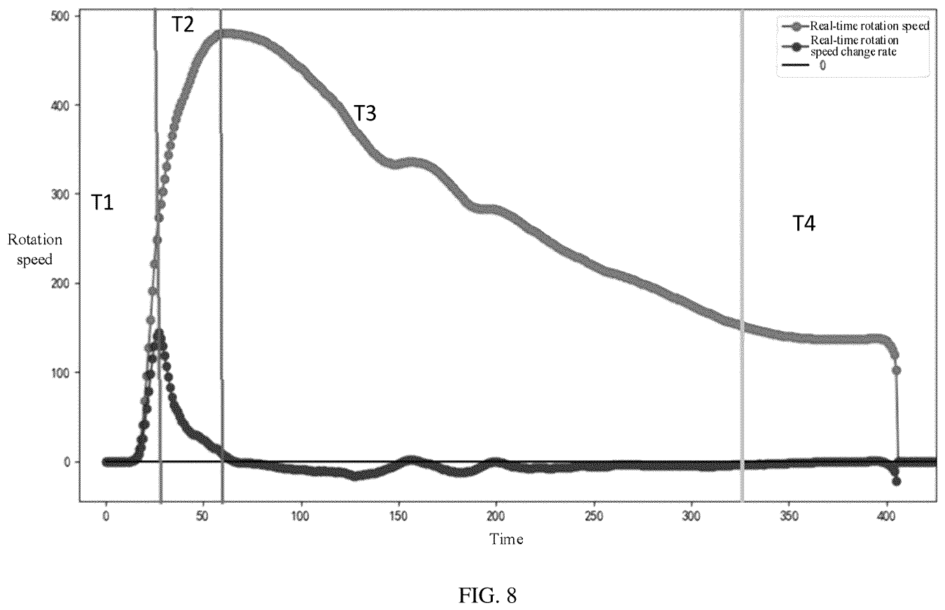

Based on the process of steps S601-S605, to facilitate understanding of the different flight stages of the present embodiment, the single cast data illustrated in FIG. 8 may be combined, the rising stage may include an acceleration rising stage T1 and a deceleration rising stage T2, and the falling stage may include a continuous falling stage T3 and a tail-end flight T4. The rising stage of the casting is driven by the inertial power thrown of the fishing bait to rotate the line spool of the fishing reel out of the line, and the rotation speed of the line spool in this stage follows the casting speed of the fishing bait, and therefore the change of the real-time rotation data (mainly referring to the real-time rotation speed of the fishing reel) from T1 to T2 in the stage is firstly accelerated and then decelerated and increased until the maximum rotation speed of this casting is reached (i.e., the change rate of the rotation speed is zero); and then entering a continuous falling stage T3, at this moment, the inertia power of the fishing bait casting is continuously reduced, and a certain braking force needs to be applied to the line spool of the fishing reel so as to avoid the fishing reel rotating speed being greater than the line outlet speed and causing the bird-nest; and the fishing reel is continuously reduced from the maximum rotation speed to the predicted casting finish rotation speed by applying the braking force, and then entering a tail-end flight stage T4 until the actual casting end, and the identification and division of the casting stage are completed.

Based on the divided four stages, the acceleration rising stage T1 and the deceleration rising stage T2 relatively do not need to add too much braking force to the line spool of the fishing reel, so the braking force corresponding to the rising stage can be set as a fixed braking force, for example, the fixed braking force can be selected from the range where the duty cycle of the braking force is 0%, 10%. Preferably, the fixed braking force corresponding to the rising stage may be set to 0% in order not to interfere with the subsequent calculation of the braking gear. However, in the falling stage T3 and the tail-end flight T4, a real-time braking force needs to be added to the line spool of the fishing reel so as to realize intelligent braking control, see in particular the following two embodiments for calculating the real-time braking force.

Further, the predicted casting finish rotation speed in step S604 can be obtained by a pre-trained casting model, wherein each casting posture corresponds to a casting model, and the specific method for calculating the predicted casting finish rotation speed is as follows:

The linear model is pre-trained based on the casting strength, casting line angle, and the maximum rotation speed of the fishing reel. The model formula for the linear model is as follows: throw_end_speed=throw_force*a+throw_angle*b+max_speed*c+b;

Here, throw_end_speed represents the casting finish rotation speed predicted for this casting.

Throw_force represents the maximum value of the triaxial acceleration calculated by the motion sensor in the actual casting, i.e., represents the casting strength;

Throw_angle represents the angle between the fishing rod and the ground when starting to pay off when casting, which can be calculated from the data of the motion sensor;

Max_speed represents the maximum rotation speed generated at the time of actual casting.

Based on the casting model obtained after training, taking FIG. 8 as an example, this casting can obtain that the predicted casting finish rotation speed is 150 through the above-mentioned formula, but the line of the fishing reel is still outgoing in the actual casting due to various factors, and the later stage is T4 stage, also called tail flight stage.

Two embodiments of calculating the real-time braking force in the falling stage in the calculation step S502 will be described below.

### Embodiment I

In one embodiment, step S502 includes:
calculating the real-time braking force G_{falling} of the fishing reel in the falling stage according to the following formula:

$${G}_{falling} = v / max ( v ) * Fi + K , {G}_{falling} ∈ ( {H}_{i} , {H}_{j} ) ;$$

wherein v represents a real-time rotation speed of the fishing reel in the falling stage, max (v) represents a maximum rotation speed of the current casting, Fᵢ represents a falling coefficient corresponding to the current braking gear of the current braking mode, K represents an anti-bird-nest protection value, and Hᵢ and Hⱼ represent a lower limit value of the braking force and an upper limit value of the braking force corresponding to the current braking gear of the current braking mode.

In this embodiment, in the falling stage during casting, based on the preset braking force coefficient confirmed by the current braking mode and the current braking gear, the preset braking force coefficient (i.e., Fᵢ, K, Hᵢ and Hⱼ) and the real-time rotation data (i.e., v and max(v)) are substituted into the above-mentioned formula to calculate the braking force, i.e. the real-time braking force G_{falling} corresponding to the falling stage during casting can be output to fall.

### Embodiment II

In one embodiment, step S502 includes:
calculating the real-time braking force G_{falling} of the fishing reel in the falling stage according to the following formula:

$${G}_{falling} = v * {v}_{i} + a * {a}_{i} + v / max ( v ) * {F}_{i} + K , {G}_{falling} ∈ ( {H}_{i} , {H}_{j} ) ;$$

Wherein v represents a real-time rotation speed of the fishing reel in the falling stage, vᵢ represents a frequency coefficient corresponding to the current braking gear of the current braking mode, a represents a rate of change of the real-time rotation speed of the fishing reel in the falling stage, aᵢ represents a frequency change coefficient corresponding to the current braking gear of the current braking mode, max(v) represents a maximum rotation speed of the casting, Fᵢ represents the falling coefficient corresponding to the current braking gear of the current braking mode, K represents an anti-bird-nest protection value, and Hᵢ and Hⱼ respectively represent a lower limit value of the braking force and an upper limit value of the braking force corresponding to the current braking gear of the current braking mode.

In this embodiment, in the falling stage during casting, based on the preset braking force coefficient confirmed by the current braking mode and the current braking gear, substituting the preset braking force coefficient (i.e. vᵢ, aᵢ, Fᵢ, K, Hᵢ and Hⱼ) and the real-time rotation data (i.e. v, a and max(v)) into the above-mentioned formula to calculate the braking force, i.e. outputting the real-time braking force G_{falling} corresponding to the falling stage during casting to decrease.

In the real-time braking force algorithms of Embodiment I and Embodiment II described above, there are different uses in different scenarios, for example, the rotation speed of the fishing reel in the wind-resistant braking mode corresponding to the wind-resistant bait changes more obviously, and the algorithm in Embodiment II can be used for calculation to have a better braking effect. In contrast, the braking mode with a relatively gentle rotation speed of the fishing reel can use the algorithm of Embodiment I to calculate the real-time braking force, with a better braking effect.

Based on the above-mentioned algorithms of Embodiment I and Embodiment II, the obtained real-time braking force at the falling stage of the cast of the fishing reel is linearly changed, which solves the problem of sudden change of braking force during casting, and makes the cast smoother.

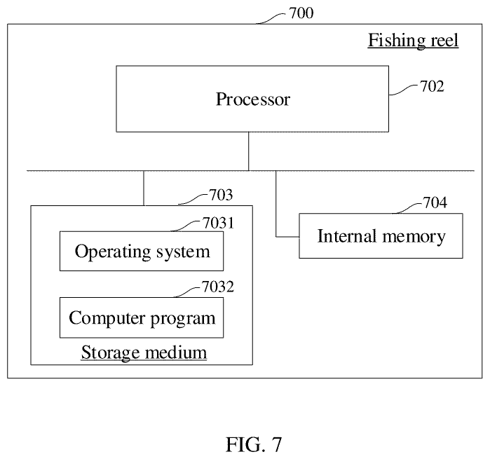

Embodiments of the present invention also provide a fishing reel for performing any of the foregoing embodiments of the intelligent braking method. Specifically, referring to FIG. 7, FIG. 7 is a schematic block diagram of a fishing reel provided by an embodiment of the present invention.

As shown in FIG. 7, the fishing reel 700 includes a processor 702, a memory, which may include a storage medium 703 and an internal memory 704, and an interface 705 connected by a system bus 701.

The storage medium 703 may store an operating system 7031 and a computer program 7032. The computer program 7032, when executed, may cause the processor 702 to perform the fishing data calculation method described above.

The processor 702 is used to provide computing and control capabilities to support the operation of the entire fishing reel 700.

The internal memory 704 provides an environment for the operation of the computer program 7032 in the storage medium 703, which when executed by the processor 702, causes the processor 702 to perform the intelligent braking method described above.

When using the fishing reel cast of the embodiment of the present invention, based on the collected real-time cast data, firstly identifying a current casting posture and a current bait type so as to confirm a current braking mode, and then continuing to confirm a current braking gear and a real-time braking force required in the current braking mode based on the real-time cast data; the real-time braking force changes linearly in the process of casting fishing reels, which solves the problem of sudden change of braking force and makes casting more smooth; the user does not need to manually adjust the braking mode and braking gear, the whole braking process is completed automatically, and the user experience is better.

Based on the function of automatically adjusting the braking mode and braking gear, the fishing reel can be designed in different styles without a knob or with a knob, which adds more diversified options for the product. The style without a knob can make the appearance of a fishing reel more concise, while the style with a knob retains the knob shift operation habit of traditional fishing reel, which meets the needs of different users.

It will be clear to a person skilled in the art that, for the convenience and brevity of the description, reference may be made to the corresponding processes in the previously described method embodiments for the specific working process of the fishing reel described above, which will not be described in detail here. The structure shown in FIG. 7 is merely a block diagram of a portion of the structure of a fishing reel related to the solution of the present application and does not constitute a limitation of the fishing reel 700. Other structures of the fishing reel 700 are well known to those skilled in the art and will not be described in detail herein.

Although the preferred embodiments of the present invention have been disclosed for illustrative purposes, those skilled in the art will appreciate that various modifications, additions, and substitutions are possible, without departing from the scope and spirit of the invention as disclosed in the accompanying claims. Accordingly, the protection sought herein is as set forth in the claims below.

1. An intelligent braking method applied to a fishing reel, comprising:
collecting real-time casting data of the fishing reel during casting;
identifying a current casting posture and/or a current bait type according to the real-time casting data, and confirming a current braking mode; and
calculating a current braking gear required in the current braking mode according to the real-time casting data, and outputting a corresponding real-time braking force.

2. The intelligent braking method according to claim 1, wherein the collecting real-time casting data of the fishing reel during casting comprises:
collecting three-axis angular acceleration data of the fishing reel during casting via a motion sensor provided on the fishing reel to obtain real-time dynamic motion data;
collecting the rotation speed of the line spool of the fishing reel during casting via a speed detection module provided on the fishing reel to obtain real-time rotation data.

3. The intelligent braking method according to claim 2, wherein the identifying a current casting posture and/or a current bait type according to the real-time casting data, and confirming a current braking mode, comprises:
inputting the real-time dynamic motion data into a posture classification model to perform casting posture prediction, and outputting the current casting posture;
matching a braking mode corresponding to the current casting posture in a preset first braking mode table as a current braking mode.

4. The intelligent braking method according to claim 2, wherein the identifying a current casting posture and/or a current bait type according to the real-time casting data, and confirming a current braking mode, comprises:
inputting real-time rotation data into a bait type classification model for bait type prediction, and outputting the current bait type;
matching a braking mode corresponding to the current bait type in a preset second braking mode table as a current braking mode.

5. The intelligent braking method according to claim 2, wherein the identifying a current casting posture and/or a current bait type according to the real-time casting data, and confirming a current braking mode, comprises:
inputting the real-time dynamic motion data into a posture classification model to perform casting posture prediction, and outputting the current casting posture;
inputting real-time rotation data into a bait type classification model for bait type prediction, and outputting the current bait type; and
matching a corresponding braking mode in a preset third braking mode table as a current braking mode according to the current casting posture and the current bait type.

6. The intelligent braking method according to claim 2, wherein the calculating a current braking gear required in the current braking mode according to the real-time casting data, and outputting a corresponding real-time braking force, comprises:
inputting rotation speed data in a rising stage from the real-time rotation data into a gear linear model corresponding to the current braking mode for fitting processing, and outputting the current braking gear required in the current braking mode;
acquiring a current preset braking force coefficient corresponding to the current braking gear in the current braking mode; and
performing braking force calculation according to the current preset braking force coefficient and the real-time rotation data, and outputting the corresponding real-time braking force.

7. The intelligent braking method according to claim 6, wherein the performing braking force calculation according to the current preset braking force coefficient and the real-time rotation data, and outputting the corresponding real-time braking force, comprises:
in the rising stage of casting, outputting the real-time braking force as a fixed braking force, wherein the selected value range of the braking duty cycle of the fixed braking force is [0%, 10%];
in the falling stage of casting, inputting the current preset braking force coefficient and real-time rotation data into a braking force algorithm for real-time braking force calculation, and outputting a real-time braking force corresponding to the falling stage.

8. The intelligent braking method according to claim 7, wherein in the falling stage of casting, the inputting the current preset braking force coefficient and the real-time rotation data into a braking force algorithm to perform a real-time braking force calculation, and outputting the real-time braking force corresponding to the falling stage, comprises:
calculating the real-time braking force G_{falling} of the fishing reel in the falling stage according to the following formula:
$${G}_{falling} = v / max ( v ) * {F}_{i} + K , {G}_{falling} ∈ ( {H}_{i} , {H}_{j} )$$
wherein v represents a real-time rotation speed of the fishing reel in the falling stage, max (v) represents a maximum rotation speed of the current casting, Fᵢ represents a falling coefficient corresponding to the current braking gear of the current braking mode, K represents an anti-bird-nest protection value, and Hᵢ and Hⱼ respectively represent a lower limit value of the braking force and an upper limit value of the braking force corresponding to the current braking gear of the current braking mode.

9. The intelligent braking method according to claim 7, wherein in the falling stage of casting, the inputting the current preset braking force coefficient and the real-time rotation data into a braking force algorithm to perform a real-time braking force calculation, and outputting the real-time braking force corresponding to the falling stage, comprises:
calculating the real-time braking force G_{falling} of the fishing reel in the falling stage according to the following formula:
$${G}_{falling} = v * {v}_{i} + a * {a}_{i} + v / max ( v ) * {F}_{i} + K , {G}_{falling} ∈ ( {H}_{i} , {H}_{j} ) ;$$
Wherein v represents a real-time rotation speed of the fishing reel in the falling stage, vᵢ represents a frequency coefficient corresponding to the current braking gear of the current braking mode, a represents a rate of change of a real-time rotation speed of the fishing reel in the falling stage, aᵢ represents a frequency change coefficient corresponding to the current braking gear of the current braking mode, max(v) represents a maximum rotation speed of the casting, Fᵢ represents a falling coefficient corresponding to the current braking gear of the current braking mode, K represents an anti-bird-nest protection value, and Hᵢ and Hⱼ respectively represent a lower limit value of the braking force and an upper limit value of the braking force corresponding to the current braking gear of the current braking mode.

10. The intelligent braking method according to claim 2, further comprising:
acquiring real-time rotation speed and real-time rotation speed change rate in real-time rotation data;
setting the casting stage from the time point of starting casting to the maximum rotation speed change rate as the acceleration rising stage in the rising stage;
setting the casting stage from the maximum rotation speed change rate to the maximum rotation speed as the deceleration rising stage in the rising stage;
setting the casting stage from the maximum rotation speed to the predicted casting finish rotation speed as the continuous falling stage in the falling stage; and
setting the time point from the predicted casting finish rotation speed to the actual casting finish as the tail-end flight stage in the falling stage.

11. A fishing reel, comprising a memory and a processor, the memory having stored therein a computer program, which when executed by the processor implements the intelligent braking method according to claim 1.

12. A fishing reel, comprising a memory and a processor, the memory having stored therein a computer program, which when executed by the processor implements the intelligent braking method according to claim 2.

13. A fishing reel, comprising a memory and a processor, the memory having stored therein a computer program, which when executed by the processor implements the intelligent braking method according to claim 3.

14. A fishing reel, comprising a memory and a processor, the memory having stored therein a computer program, which when executed by the processor implements the intelligent braking method according to claim 4.

15. A fishing reel, comprising a memory and a processor, the memory having stored therein a computer program, which when executed by the processor implements the intelligent braking method according to claim 5.

16. A fishing reel, comprising a memory and a processor, the memory having stored therein a computer program, which when executed by the processor implements the intelligent braking method according to claim 6.

17. A fishing reel, comprising a memory and a processor, the memory having stored therein a computer program, which when executed by the processor implements the intelligent braking method according to claim 7.

18. A fishing reel, comprising a memory and a processor, the memory having stored therein a computer program, which when executed by the processor implements the intelligent braking method according to claim 8.

19. A fishing reel, comprising a memory and a processor, the memory having stored therein a computer program, which when executed by the processor implements the intelligent braking method according to claim 9.

20. A fishing reel, comprising a memory and a processor, the memory having stored therein a computer program, which when executed by the processor implements the intelligent braking method according to claim 10.
